(19) United States
(12) Patent Application Publication
(10) Pub. No.: US 2006/0181124 A1
(43) Pub. Date: Aug. 17, 2006

(54) Remote controlled baby seat

(76) Inventor: Tina Kish, Brick, NJ (US)

Correspondence Address: CLIFFORD G. FRAYNE, 136 DRUM POINT RD, SUITE 7A, BRICK, NJ, 08723, US

(21) Appl. No.: 11/338,538

(22) Filed: Jan. 25, 2006

Related U.S. Application Data
(60) Provisional application No. 60/648,742, filed on Feb. 2, 2005.

(51) Int. Cl. A47C 1/08; A47C 13/00; B60N 2/02; B62B 7/00; A47C 7/62

(52) U.S. Cl. 297/256.1; 296/97.21; 296/65.01; 296/65.05; 297/1; 297/217.1

(57) ABSTRACT

A baby car seat for mounting in a vehicle and securing a baby or infant therein, the baby car seat having a base member and a shell-like seat member secured thereto, the shell-like seat member securing the baby therein, the base member and shell-like seat member being in communication by means of a motor means and gearing mechanism, the base member having a receptor mounted therein, communicatable from the front seat of the vehicle, the parent operator of the vehicle having a remote control unit which will communicate with the receptor so as to cause the motor and gearing mechanism to move the shell portion of the baby seat from an upright position to a reclined position or vice versa, depending upon the alertness of the baby or infant secured within the baby car seat.

### RELATED APPLICATIONS

Applicant claims the benefit of provisional application 60/648,742, filed Feb. 2, 2005.

### BACKGROUND OF THE INVENTION

1. Field of the Invention

The present invention relates to baby seats for use in vehicles, and in particular, to baby seats which are most often utilized and secured in the rear seat of a vehicle and a means for adjusting the orientation of the baby seat by remote control.

2. Description of the Prior Art

The use of baby seats in vehicles has been mandated by law for quite some time. Baby seats are used by parents with infants to secure the baby securely within a seat designed to fit the anatomy and dimensions of the baby while traveling in a vehicle. Typically the baby car seat is comprised of a base member which is in communication and contact with the rear seat of the vehicle, the base member having a shell member secured and mounted thereto which is partially rotatable from an upright to a reclined position, such rotation being manually accomplished, depending upon whether or not the baby or infant is awake or asleep. Typically, the baby car seat has its own padding and restraining belts and is secured to the rear seat of the vehicle by a plurality of apertures which utilize not only the standard seat belts found in the vehicle, but also additional securing belts secured to the rear of the baby seat. Baby seats in this configuration may be secured with the baby facing forwardly, while positioned in the baby car seat in the rear seat of the vehicle or with the baby or infant facing rearwardly while positioned in the car baby seat in the rear seat of the vehicle.

On a great many occasions only one parent is in the vehicle and operating it while the child is secured to the rear seat at a location where the parent can view the child. The Applicant herein has recognized a problem which has not heretofore been addressed by the manufacturers of baby car seats. A parent while operating the vehicle with the child or infant in a car seat positioned in the rear seat will often notice that the child or infant has been positioned in the car seat in an upright position initially when the travel commences. Children or infants of this age are often prone to falling asleep quickly because of the motion and noise of the vehicle while traveling. Therefore an infant or child when in an upright position in a baby car seat will often fall asleep and his head and shoulders will droop onto his chest which may be an inappropriate anatomical position for a child or infant of this age. If a single parent is driving the car, the only option for the parent is pull to the side of the road and adjust the baby car seat from the upright position to the incline position such that the baby's head and shoulders are now off of its chest and resting in a semi-supine position. This type of action disrupts the parents attention to the road, delays the trip and is time consuming.

A parent most often adjusts the rearview mirror upon starting out upon the trip with a child in a baby car seat in the rear seat of the vehicle so that the parent can glance into the rearview mirror to ascertain the status and alertness of the child. Alternatively the parent will secure the baby seat to the passenger side of the rear seat to facilitate viewing the infant. When the child falls asleep and assumes the position where the head and shoulders are forward upon the chest cavity, the parent has no choice but to stop the vehicle and turn around and if not exit the vehicle in order to adjust the baby car seat from the upright to the inclined position.

Applicant's invention relates to a baby car seat having a motorized gearing mechanism operable by remote control which would allow a parent driving the vehicle to automatically adjust the baby car seat in the rear seat of the vehicle without having to stop the vehicle and manually adjust the car seat, the motorized gearing mechanism for accomplishing this being either battery powered or powered off of the vehicle battery using a remote control unit and an LED, communicating with a small motor, all of which would be located in the base of the baby car seat and not susceptible to finger or toe contact by the baby or infant.

### OBJECTS OF THE INVENTION

An object of the present invention is to provide for a novel baby car seat having a remote controlled motor and gearing mechanism formed in its base, allowing a parent operating the vehicle to remotely, automatically, shift the position of the baby car seat from an upright position to a reclined position or vice versa without the necessity of stopping the vehicle and manually accomplishing the aforesaid.

### SUMMARY OF THE INVENTION

A baby car seat for mounting in a vehicle and securing a baby or infant therein, the baby car seat having a base member and a shell-like seat member secured thereto, the shell-like seat member securing the baby therein, the base member and shell-like seat member being in communication by means of a motor means and gearing mechanism, the base member having a receptor mounted therein, communicatable from the front seat of the vehicle, the parent operator of the vehicle having a remote control unit which will communicate with the receptor so as to cause the motor and gearing mechanism to move the shell portion of the baby seat from an upright position to a reclined position or vice versa, depending upon the alertness of the baby or infant secured within the baby car seat.

### BRIEF DESCRIPTION OF THE DRAWINGS

These and other objects of the present invention will become apparent, particularly when taken in light of the following illustrations wherein:

FIG. 1 is a side exploded view of a typical baby car seat;

FIG. 2 is a front view of a typical baby car seat;

FIG. 3 is a front exploded view of a base of a baby car seat incorporating Applicant's remote controlled assembly;

FIG. 4 is a top view of the base of a baby car seat incorporating Applicant's remote control assembly;

FIG. 5 is a partial side view of the remote baby seat and gear mechanism; and

FIG. 6 is a top view of an alternative embodiment of the base member.

### DETAILED DESCRIPTION OF THE INVENTION

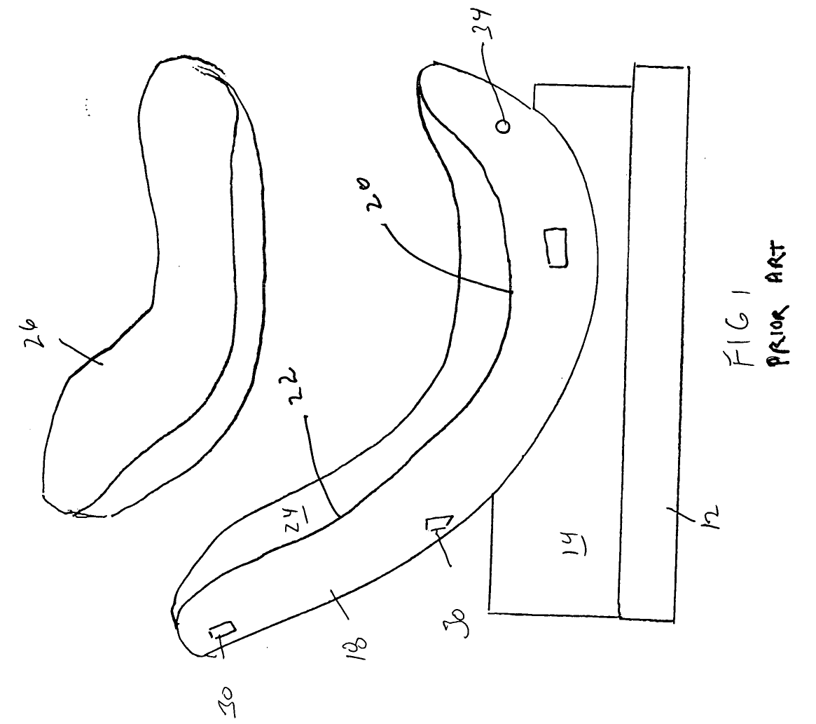

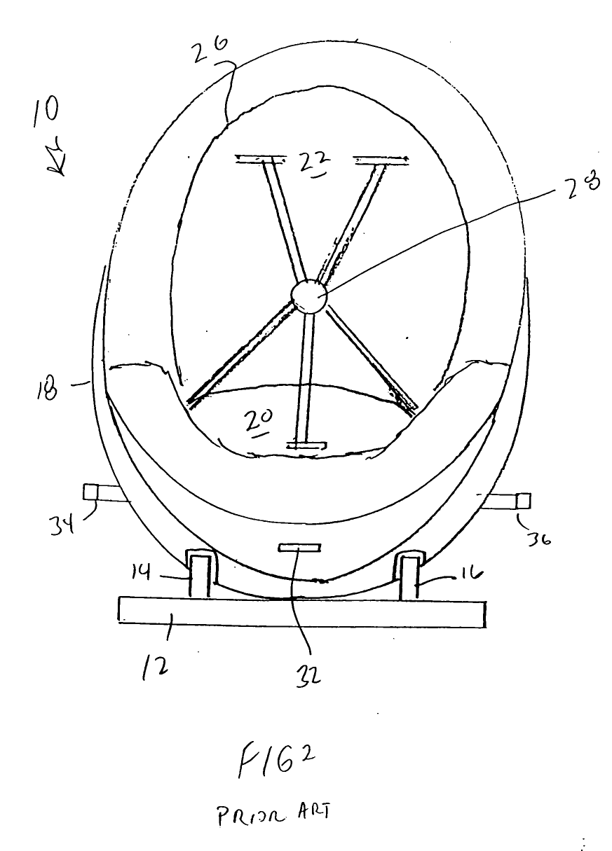

FIG. 1 is a side view of a typical baby seat and FIG. 2 is a front view of a typical baby seat. The baby seat 10 consists of a base member 12 having two upstanding support arms 14 and 16. Support arms 14 and 16 support the baby seat 10 by means of a plurality of cross members (not shown). The baby seat itself comprises an outer shell member 18 formed of high impact plastic. Shell member 18 is arcuate in shape having a seat portion 20 and a back portion 22. Shell member 18 is normally layered with Styrofoam or similar material 24 for energy absorption and to provide the general arcuate shape of the seat and back portion. The Styrofoam material 24 is overlaid with a cushion cover 26 made of resilient cushiony material. The baby seat itself incorporates a harness system 28 which engages the shoulder and groin area of the infant. This harness system 28 is adjustable by the patent depending upon the size of the infant or child. The rear portion of the shell has a plurality of apertures 30 there through to accommodate the normal seat belt system in the rear seat of a vehicle in order to secure the baby seat 10 in a secure position to the seat. The front of the baby seat 10 has an engagement handle 32 in communication with the mounting system to allow for the baby seat to be manually slidably positioned from an upright position to a inclined or reclined position depending upon whether or not the baby is awake and alert or asleep. The engagement handle is manually engaged and allows the shell member 18 of the baby seat to partially rotate on the upstanding arm members 14 and 16 from base member 12. The upstanding arm members ride within a cutout groove in the shell portion of the baby seat. In addition to the engagement handle, there are adjustment knobs 34 and 36 on either side of the front of the shell member that adjust the tension in the harness member 28.

In many instances a single parent is present in the vehicle and operating the vehicle. The baby seat 10 is located in the rear seat of the vehicle, and when a child is secured therein, and falls asleep with the baby seat in the upright position, the child's head will most normally fall forward with its chin resting on its chest. Such a position is not advisable from a chiropractic position with respect to an infant or child in the developing stages. A parent recognizing this fact must pull the vehicle to the side of the road and manually engage the engagement handle 32 in order to pivot the baby seat 10 from an upright to a reclined position.

The reverse occurs when the baby is in a reclined position because the baby or infant is asleep, and then awakes. The parent must then manually engage the engagement handle 32 and adjust the baby seat 10 from the reclined position to the upright position. This can detract from the driver's attention to the road and further delay the trip.

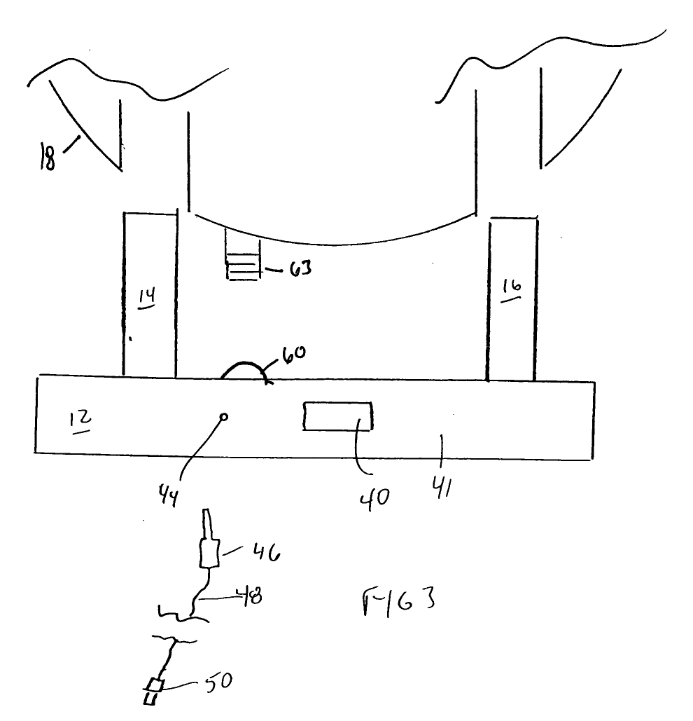

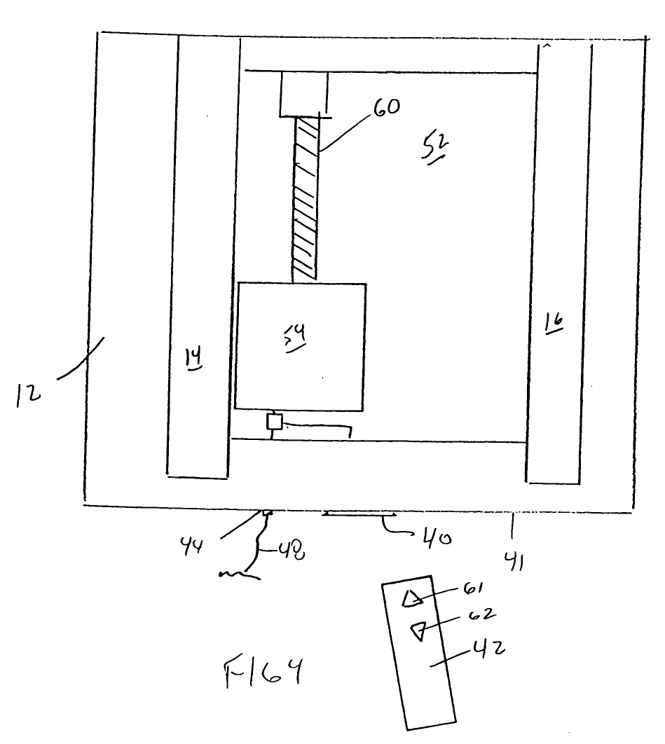

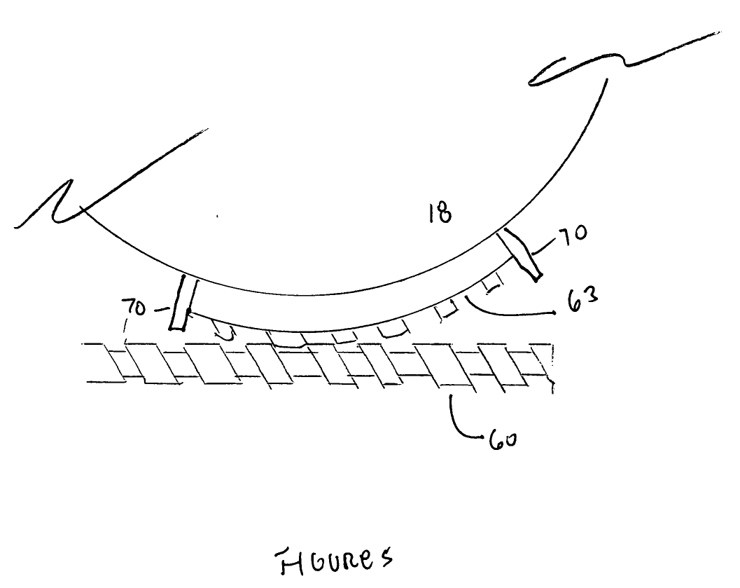

FIGS. 3 and 4 are a front view and a top view of a modified baby seat with the seat removed incorporating Applicant's invention of a remote control motor which would allow the parent to adjust the baby seat from the upright to the reclined position and vice versa, without having to stop the vehicle and manually engage the engagement handle. FIG. 5 is a partial side view of one embodiment of the remote control gearing mechanism.

FIG. 3 is front exploded view of the base and baby seat. The baby seat base 12 is normally formed from two complimentary pieces of plastic secured together, which form a central cavity 52. The modifications to the base would include in one embodiment a remote control receptor 40 on front face 41 of base 12 similar to that on electrical appliances, such as televisions. The remote control receptor 40 would receive a signal from a remote control unit 42 in the possession of an individual in the front seat of the vehicle. Also formed on the front face 41 of the base 12 of the baby seat would be a power receptacle 44 for the receivable insertion of one end 46 of a power cord 48, the other end 50 of the power cord 48 having a power contact slidably receivable within a cigarette lighter receptacle in the front dashboard or on the console of the vehicle.

Mounted in cavity 52 in the base member 12 would be an electric motor 54. Electric motor 54 would be in communication with the power receptacle 44 on the front face 41 of the baby seat base 12 and in communication with the remote control receptor 40 also mounted on the front face 41 of the baby seat base 12. The electric motor would be in communication with a transport means 60, the transport means engageable with a complimentary transport means 63 on the underside of the shell 18, of the baby seat or with the cross supports upon which the baby seat is mounted such that it pivots from the inclined to the reclined position. The electric motor 54 and the transport means 60 would be of sufficient power to cause the shell of the baby seat and of the attachments thereto including the infant, to rotate from a reclined position to an inclined position or vice versa. In one embodiment, the transport means 60 and 63 could be in the form of a worm gear 60 and quarter or half bevel gear 63 arrangement from the motor 54 to the base of the shell 18 forming the baby seat as illustrated in FIGS. 4, 5, and 6. Alternatively the transport means may be belt driven with the belt having teeth or cogs engageable with a gear mounted on the underside of the shell 18.

The remote control unit 42 would have a recline button 62 and an upright button 61 with the remote control receptor 40 identifying which button was being pressed.

In operation, the baby seat would be secured in a normal manner in the rear seat of a vehicle with the child or infant secured in the seat. The power cord 48 would be connected to the base 12 of the baby seat 10 at receptacle 44 and to the receptacle for the cigarette lighter. The electric motor while engaged with the power source would not be operational until one of the indicia buttons 61 or 62 on the remote control unit 42 was depressed while pointing the remote control unit 42 at the remote control receptor 40 on the base 12 of the baby seat 10. Pressing a button would activate the electric motor 54 and move the seat from an upright to a reclined position or vice versa by depressing the alternate button. Release of the remote control button 61 or 62 would cause the electric motor to turn off and interrupt its power supply. It is intended that the electric motor have no source of power unless one of the remote control buttons on the remote control unit were depressed while the remote control unit was aimed at the remote control receptor 40. This configuration eliminates the need for the driver or parent to stop the vehicle and to manually adjust the seat. It can be accomplished from the front seat with the remote control unit without interrupting the travel of the vehicle, since the child is normally positioned in the center or passenger side of the rear seat so as to be visible to the parent while operatint the vehicle.

The electric motor and transport mechanism 54 and 60 would not have to be of substantial size, since the baby seat 10 is rather light and baby seats are utilized for children and infants up until a weight of 40 pounds. Therefore the motor would only have to maneuver the baby seat and infant with a weight totaling 50 pounds through a few inches of arc to move from upright to supine position or vice versa. Still further, since the motor 54 and transport mechanism 60 would be positioned under the shell 18 of the baby seat 10, and in the base 12 unit, there would be no contact with any of the extremities of the child. Still further, a separate safety feature is the fact that the motor is without power unless one of the remote buttons 61 or 62 on the remote control unit 40 is depressed. Another safety feature would include preset stops 70 on the worm gear 60 and bevel gear 63 to limit the rotation to preset limits. Other safety features and other transport mechanisms may be developed without departing from the spirit and scope of the invention.

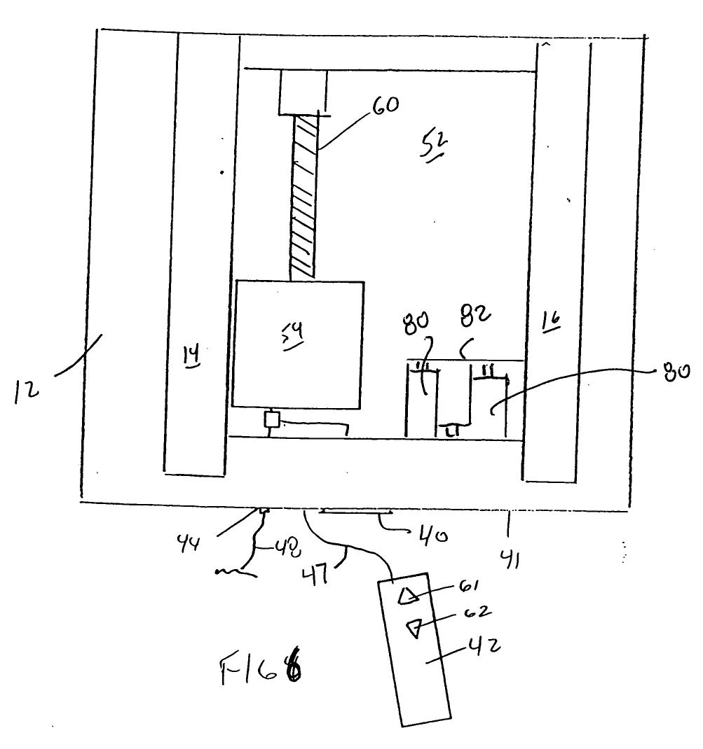

Still further, in a second embodiment the power source could be a plurality of batteries 80 with a battery compartment 82 incorporated in base 12 at a convenient location (See FIG. 6). Additionally, the remote control 42 could be hardwired 47 to the base 12 without the need for the remote control receptor 40 to prevent the infants blankets from blocking the remote control receptor. The remote control 42 would operate in the same manner previously discussed.

While the present invention has been described with respect to the exemplary embodiments thereof, it will be recognized by those of ordinary skill in the art that many modifications or changes can be achieved without departing from the spirit and scope of the invention. Therefore it is manifestly intended that the invention be limited only by the scope of the claims and the equivalence thereof.

I claim:

1. A remote controlled baby seat for the rotation of the baby seat shell from a substantially upright sitting position to a reclined or supine position and vice versa, the remote controlled baby seat comprising:
a base member having a lower surface for contact with a support surface, a front wall, rear wall, opposing side walls and an upper surface, said upper surface having a recessed cavity, said upper surface further having two upright parallelledy disposed pedestal members oriented from said front wall of the base member to said rear wall of the base member, said pedestal members positioned on opposing sides of said recessed cavity;
an outer baby seat shell member arcuate in shape having a seat portion, a back portion, and opposing arcuate side walls, said shell member having integrally formed therein, on a lower surface, a pair of spaced apart channels compatible with and mating with said spaced apart pedestals of said base member and pivotable thereon, said baby seat shell member being overlaid on an upper surface thereof, with a layer of energy absorbent material, said energy absorbent material being further overlaid with a resilient cushion layer for receipt of an infant;
a first harness system integral with said baby seat for securing an infant in said baby seat on top of said resilient cushion layer;
a second harness system cooperable with a seat belt system of a vehicle so as to position and secure said baby seat on the seat of a vehicle;
a motor means and first transport mechanism positioned in said recessed cavity of said base member, said motor means and said first gear mechanism in communication with a second transport mechanism positioned on said underside of said baby seat shell member and said motor means in further communication with a receptor sensor window on front wall of said base member of said baby seat and with a power source; and
a remote control unit in communication with said base member, said remote control unit having indicia allowing a user to cause said baby seat shell member, energy absorbing material, resilient cushiony layer, said first harness system and said infant, to selectively rotate from an upright sitting position to a horizontal, supine sleeping position and from a horizontal supine sleeping position to an upright sitting position or a selected position there between, said remote control unit in communication with a power source.

2. A remote controlled baby seat in accordance with claim 1 wherein said first transport mechanism positioned in said recessed cavity of said base member comprises a worm gear and said second transport mechanism comprises a bevel gear secured to said outer baby seat shell member, rotation of said worm gear imparting rotation to said bevel gear rotating said outer baby seat shell member and contents from an upright position to a supine position or from a supine position to an upright position or any point there between.

3. The remote control baby seat in accordance with claim 1 wherein said motor means is in communication with the electrical circuitry of the vehicle by means of a power cord engageable with a lighter receptacle.

4. The remote control baby seat in accordance with claim 1 wherein said motor means is in communication with a power source, said power source comprising a battery means within said cavity of said base member.

5. The remote control baby seat in accordance with claim 1 wherein said remote control unit is in communication with the power source, said power source comprising a battery pack within said remote control unit.

6. The remote control baby seat in accordance with claim 1 wherein said remote control unit having indicia allowing a user to cause said baby seat shell member, energy absorbing material, resilient cushiony layer, said first harness system and said infant to selectively rotate, said indicia comprising a first button having an indicia indicating upward rotation and a second button indicating downward rotation.

7. The remote control baby seat in accordance with claim 1 wherein said motor means is powered only when an indicia on said remote control unit is activated.

8. The remote control baby seat in accordance with claim 2 wherein said first and second transport means are formed with stop means limiting the rotation of said remote control baby seat to a preset upright and preset supine orientation.

9. The remote control baby seat in accordance with claim 6 wherein said remote control unit comprises a remote control receptor on said base of said remote controlled baby seat in selective light communication with said remote control unit.

10. The remote control baby seat in accordance with claim 6 wherein said remote control unit is hardwired to said base of said remote controlled baby seat.
